(19) United States
(12) Patent Application Publication
(10) Pub. No.: US 2020/0401680 A1
(43) Pub. Date: Dec. 24, 2020

(54) METHOD AND APPARATUS FOR AUTHENTICATING USER

(71) Applicant: Netmarble Corporation, Seoul (KR)

(72) Inventors: Sun Keun SHIM, Seoul (KR); Jeong Pil CHEON, Seoul (KR); Gi Hun HAN, Seoul (KR)

(73) Assignee: Netmarble Corporation, Seoul (KR)

(21) Appl. No.: 16/907,483

(22) Filed: Jun. 22, 2020

(30) Foreign Application Priority Data
Jun. 24, 2019 (KR) 10-2019-0074899

(51) Int. Cl. G06F 21/32; G06F 21/36

(52) U.S. Cl. CPC G06F 21/32; G06F 21/36

(57) ABSTRACT

Disclosed is a user authentication method and apparatus. The user authentication method includes transmitting, to a user terminal, a visual authentication code that is recognized differently according to color vision deficiency, receiving, from the user terminal, a user input corresponding to the visual authentication code, and determining a user authentication result of a user based on a comparison result obtained by comparing the user input to a reference value determined based on pre-enrolled color vision information of the user.

### CROSS-REFERENCE TO RELATED APPLICATION(S)

This application claims the benefit of Korean Patent Application No. 10-2019-0074899, filed on Jun. 24, 2019, in the Korean Intellectual Property Office, the disclosure of which is incorporated herein by reference.

### BACKGROUND

### 1. Field of the Invention

One or more example embodiments relate to user authentication technology.

### 2. Description of the Related Art

Currently, user authentication through a mobile device such as a mobile phone is performed by sending a visual authentication code to a mobile phone in the name of a user and receiving an input of the visual authentication code. According to this method, a server requesting user authentication from the user performs the user authentication by verifying only whether the user owns the previously registered mobile phone in the name of the user, and thus it is difficult to accurately perform user authentication. In particular, if the user loses the mobile phone in the name of the user, another person who found the mobile phone may abuse a security code.

### SUMMARY

According to an aspect, there is provided a user authentication method based on color vision information, the user authentication method including transmitting, to a user terminal, a visual authentication code that is recognized differently according to color vision deficiency, receiving, from the user terminal, a user input corresponding to the visual authentication code, and determining a user authentication result of a user based on a comparison result obtained by comparing the user input to a reference value determined based on pre-enrolled color vision information of the user.

The determining may include determining that a user authentication of the user is successful, if an input value with respect to the visual authentication code included in the user input is the same as the reference value.

The determining may include determining that a user authentication of the user is failed, if an input value with respect to the visual authentication code included in the user input is different from the reference value.

The pre-enrolled color vision information may be determined in a user enrollment procedure based on a user input with respect to color vision information of the user, and include information regarding whether the user has color vision deficiency.

The pre-enrolled color vision information may be enrolled information regarding whether the user has color vision deficiency, determined based on an input value with respect to a visual code that is read differently according to color vision deficiency input in the user enrollment procedure.

The pre-enrolled color vision information may be enrolled information regarding whether the user has color vision deficiency, determined based on a selected value with respect to color vision deficiency input in the user enrollment procedure.

The visual authentication code may be provided in the form of an image based on a color vision test, and may be a number, a character, or a combination thereof that is read differently according to normal vision and color vision deficiency.

The visual authentication code may be a number, a character, or a combination thereof that is read differently according to at least one of protanomaly, deuteranomaly, tritanomaly, protanopia, deuteranopia, tritanopia, cone monochromatism, and rod monochromatism.

According to another aspect, there is provided a user authentication apparatus for performing a user authentication method, the user authentication apparatus including a memory and a processor, wherein the memory may be configured to store instructions executable by the processor, and when the instructions are executed by the processor, the processor may be configured to transmit, to a user terminal, a visual authentication code that is recognized differently according to color vision deficiency, receive, from the user terminal, a user input corresponding to the visual authentication code, and determine a user authentication result of a user based on a comparison result obtained by comparing the user input to a reference value determined based on pre-enrolled color vision information of the user.

The processor may be configured to determine that a user authentication of the user is successful, if an input value with respect to the visual authentication code included in the user input is the same as the reference value.

The processor may be configured to determine that a user authentication of the user is failed, if an input value with respect to the visual authentication code included in the user input is different from the reference value.

The pre-enrolled color vision information may be determined in a user enrollment procedure based on a user input with respect to color vision information of the user, and include information regarding whether the user has color vision deficiency.

The pre-enrolled color vision information may be enrolled information regarding whether the user has color vision deficiency, determined based on an input value with respect to a visual code that is read differently according to color vision deficiency input in the user enrollment procedure.

The pre-enrolled color vision information may be enrolled information regarding whether the user has color vision deficiency, determined based on a selected value with respect to color vision deficiency input in the user enrollment procedure.

The visual authentication code may be provided in the form of an image based on a color vision test, and is a number, a character, or a combination thereof that is read differently according to normal vision and color vision deficiency.

The visual authentication code may be a number, a character, or a combination thereof that is read differently according to at least one of protanomaly, deuteranomaly, tritanomaly, protanopia, deuteranopia, tritanopia, cone monochromatism, and rod monochromatism.

According to another aspect, there is provided a user authentication method performed by a user terminal, the user authentication method including receiving, from a user authentication apparatus, a visual authentication code that is recognized differently according to color vision deficiency, receiving a user input corresponding to the visual authentication code, and transmitting the received user input to the user authentication apparatus, wherein the user authentication apparatus may be configured to determine a user authentication result of a user based on a comparison result obtained by comparing the user input to a reference value determined based on pre-enrolled color vision information of the user.

The user authentication apparatus may be configured to determine that a user authentication of the user is successful, if an input value with respect to the visual authentication code included in the user input is the same as the reference value, and determine that a user authentication of the user is failed, if the input value with respect to the visual authentication code included in the user input is different from the reference value.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an overall configuration of a user authentication system according to an example embodiment;

FIG. 2 is a flowchart illustrating operations of a user authentication method according to an example embodiment;

FIG. 3 is a diagram illustrating an example of a user authentication process according to an example embodiment;

FIG. 4 illustrates a screen of a user terminal receiving a visual authentication code from a user authentication apparatus according to an example embodiment;

FIG. 5 illustrates an example of a user interface for implicitly collecting color vision information of a user according to an example embodiment;

FIG. 6 illustrates an example of a user interface for explicitly collecting color vision information of a user according to an example embodiment; and

FIG. 7 is a diagram illustrating a configuration of a user authentication apparatus according to an example embodiment.

### DETAILED DESCRIPTION

Hereinafter, example embodiments will be described in detail with reference to the accompanying drawings. However, various alterations and modifications may be made to the example embodiments. Here, the example embodiments are not construed as limited to the disclosure. The example embodiments should be understood to include all changes, equivalents, and replacements within the idea and the technical scope of the disclosure.

The terminology used herein is for the purpose of describing particular example embodiments only and is not to be limiting of the example embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the example embodiments with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

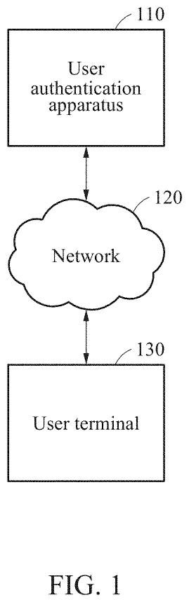

FIG. 1 is a diagram illustrating an overall configuration of a user authentication system according to an example embodiment.

A system for authenticating a user through color vision information (hereinafter, the user authentication system) may determine whether a user is authenticated based on a user input with respect to a visual authentication code provided according to a color vision test, and color vision information of the user previously enrolled by the user.

The user authentication system may provide an enhanced secure authentication method by allowing the user to input an input value with respect to the visual authentication code. The user authentication system may determine whether the user is authenticated based on the color vision information of the user implicitly or explicitly enrolled by the user, and the user input with respect to the visual authentication code. Accordingly, it is possible to determine whether the user has a mobile phone in the name of the user as well as whether the user is authenticated.

Referring to FIG. 1, the user authentication system may include a user authentication apparatus 110, a network 120, and a user terminal 130. The user authentication apparatus 110 and the user terminal 130 may communicate with each other through the network 120 (for example, the Internet, a wired/wireless local area network, or a wide area network).

The user authentication apparatus 110 may receive request data requesting user authentication of a user from a server providing game play or other services. The user authentication apparatus 110 may transmit a visual authentication code for user authentication of the user to the user terminal 130 in response to the request data. The user terminal 130 may transmit a user input with respect to the visual authentication code to the user authentication apparatus 110.

The user authentication apparatus 110 may determine whether the user is authenticated based on the user input, and color vision information of the user previously enrolled. The user authentication apparatus 110 may compare the user input to a reference value determined based on the color vision information of the user previously enrolled. If the user input is the same as the reference value, the user authentication apparatus 110 may determine that the user authentication of the user is successful. Conversely, if the user input is different from the reference value, the user authentication apparatus 110 may determine that the user authentication of the user is failed. Here, the reference value may be a value including a number, a character, or any combination thereof that may be read from the visual authentication code according to color vision deficiency.

The user authentication apparatus 110 may transmit a determination result to the server. In response to the determination that the user authentication of the user is successful, the server may provide a service related to the server, or game play. Conversely, in response to the determination that the user authentication of the user is failed, the user authentication apparatus 110 may transmit request data for requesting user authentication of the user again.

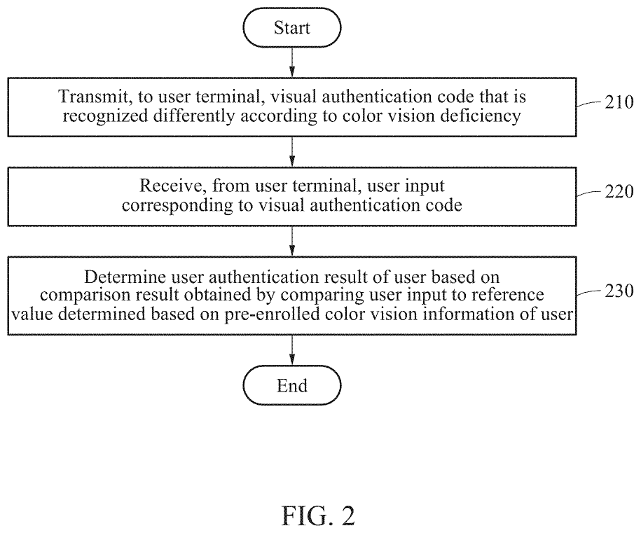

FIG. 2 is a flowchart illustrating operations of a user authentication method according to an example embodiment. A user authentication method may be performed by a user authentication apparatus described herein.

Referring to FIG. 2, the user authentication apparatus receiving a request for user authentication of a user from a server providing a service related to game play may transmit, to a user terminal, a visual authentication code that is recognized differently according to color vision deficiency, in operation 210.

The visual authentication code may be provided in the form of an image based on a color vision test, and may be a number, a character, or a combination thereof that is read differently according to normal vision and color vision deficiency. More particularly, the visual authentication code may be a number, a character, or a combination thereof that is read differently according to at least one of protanomaly, deuteranomaly, tritanomaly, protanopia, deuteranopia, tritanopia, cone monochromatism, and rod monochromatism.

For example, a user with normal vision and a user with protanomaly may read different numbers, characters, or combinations thereof from a single visual authentication code.

The user may view the visual authentication code through the user terminal and input a number, a character, or a combination thereof read from the visual authentication code into the user terminal.

In operation 220, the user authentication apparatus may receive the user input corresponding to the visual authentication code from the user terminal.

In operation 230, the user authentication apparatus may determine a user authentication result of the user based on a comparison result obtained by comparing the user input to a reference value determined based on pre-enrolled color vision information of the user. Here, the pre-enrolled color vision information may be determined in a user enrollment procedure based on a user input with respect to color vision information of the user, and include information regarding whether the user has color vision deficiency.

For example, when a user creates an account on a website to join, the user may provide the information to the website by enrolling color vision information based on a joining form provided by the website. In another example, the user may provide the information to the website by enrolling color vision information based on a form provided by the website on the website that the user joined.

The pre-enrolled color vision information may be enrolled information regarding whether the user has color vision deficiency, determined based on an input value with respect to a visual code that is read differently according to color vision deficiency input in the user enrollment procedure. In another example, the pre-enrolled color vision information may be enrolled information regarding whether the user has color vision deficiency, determined based on a selected value with respect to color vision deficiency input in the user enrollment procedure.

If the input value with respect to the visual authentication code included in the user input is the same as the reference value, the user authentication apparatus may determine that the user authentication of the user is successful. Conversely, if the input value with respect to the visual authentication code included in the user input is different from the reference value, the user authentication apparatus may determine that the user authentication of the user is failed.

That is, the user may input, into the user terminal, the user input including the input value with respect to the number, the character, or the combination thereof read from the visual authentication code. The user terminal may transmit the user input including the input value of the user to the user authentication apparatus. If the input value of the user included in the user input is the same as the reference value, the user authentication apparatus may determine that the user authentication of the user is successful. Here, the reference value may be a number, a character, or a combination thereof determined based on the pre-enrolled color vision information of the user.

For example, if a visual authentication code that is read as “71” by a user with normal vision is provided to the user and the pre-enrolled color vision information of the user is normal vision, the user authentication apparatus may determine that the user authentication of the user is successful only when both an input value provided by the user based on the visual authentication code and the reference value are “71”. Conversely, if a visual authentication code that is read as “143” by a user with deuteranomaly is provided to the user and the pre-enrolled color vision information of the user is deuteranomaly, the reference value may be “143”. In this example, if an input value provided by the user based on the visual authentication code is “143”, the user authentication apparatus may determine that the user authentication of the user is successful. However, if the input value of the user is not “143”, the user authentication apparatus may determine that the user authentication of the user is failed. The user authentication apparatus may transmit a user authentication result of the user to a server that is to provide game play or a service to the user terminal.

Through the above process, the security may be enhanced by checking color vision deficiency collected from the user in the user authentication procedure as well as whether the user has a device in the name of the user. In addition, the user may obtain an advanced effect of performing user authentication with enhanced security by only reading a visual authentication code and inputting a number read from the visual authentication code, without an additional operation.

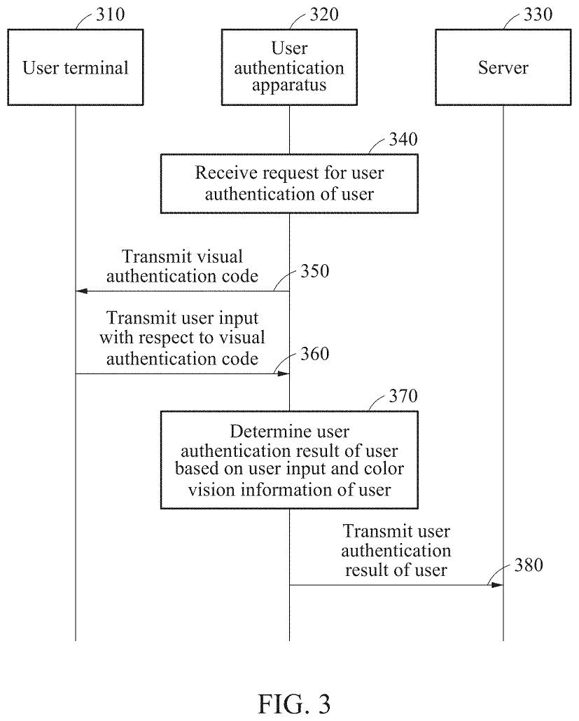

FIG. 3 is a diagram illustrating an example of a user authentication process according to an example embodiment.

Referring to FIG. 3, in operation 340, a user authentication apparatus 320 may receive a request for user authentication of a user. The request may be received from a server 330 that is to provide game play or various services to a user terminal 310. In operation 350, the user authentication apparatus 320 may transmit a visual authentication code for user authentication of the user to the user terminal 310, in response to the request for user authentication of the user. The user terminal 310 may receive, from the user authentication apparatus 320, the visual authentication code that is recognized differently according to color vision deficiency.

In operation 360, the user terminal 310 may receive a user input corresponding to the visual authentication code, and transmit, to the user authentication apparatus 320, the user input with respect to the visual authentication code received from the user. In operation 370, the user authentication apparatus 320 may determine a user authentication result of the user based on the user input and the color vision information of the user, in response to the received user input with respect to the visual authentication code.

Only when the input value of the user matches a value corresponding to the color vision information of the user, among values that may be read from the visual authentication code, the user authentication apparatus 320 may determine that the user authentication of the user is successful. For example, if the color vision information of the user is tritanomaly, and the input value of the user is the same as a value corresponding to tritanomaly, among the values that may be read from the visual authentication code, the user authentication apparatus 320 may determine that the user authentication of the user is successful. Conversely, if the color vision information of the user is normal vision, and the input value of the user is the same as a value corresponding to deuteranopia, among the values that may be read from the visual authentication code, the user authentication apparatus 320 may determine that the user authentication of the user is failed.

In operation 380, the user authentication apparatus 320 may transmit the user authentication result of the user to the server 330. Based on the user authentication result of the user, the server 330 may provide game play or a service related to the server 330 to the user terminal 310, or transmit request data for requesting user authentication of the user again to the user authentication apparatus 320.

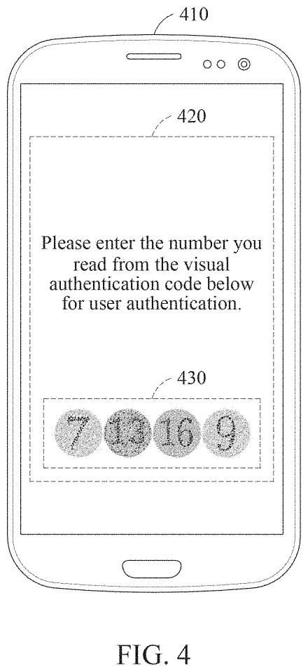

FIG. 4 illustrates a screen of a user terminal receiving a visual authentication code from a user authentication apparatus according to an example embodiment.

Referring to FIG. 4, a user authentication apparatus may transmit, to a user terminal 410, a visual authentication code 430 for user authentication of a user. The user terminal 410 may display a guide window 420 including the visual authentication code 430 on a screen. The visual authentication code 430 may be provided in a form that may be read differently according to the color vision of a user. The visual authentication code 430 may be in the form of an image based on a color vision test. The visual authentication code 430 may be read as “713169” by a user with normal vision. However, the visual authentication code 430 may be read as a different number, character, or combination thereof by a user with any one of protanomaly, deuteranomaly, tritanomaly, protanomaly, deuteranopia, tritanopia, cone monochromatism, and rod monochromatism.

The user may input an input value into the user terminal 410 based on the number, letter, or combination thereof read from the visual authentication code 430.

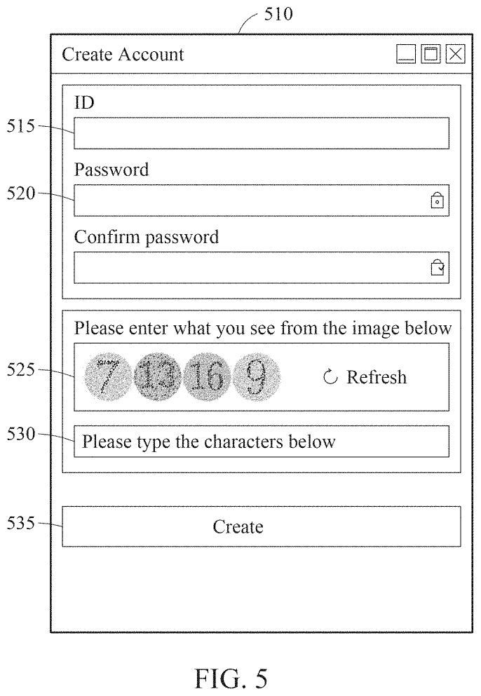

FIG. 5 illustrates an example of a user interface for implicitly collecting color vision information of a user according to an example embodiment.

A server may implicitly determine whether a user has color vision deficiency. For example, the server may naturally determine whether the user has color vision deficiency based on CAPCHA information used in an account creation or login process. Through this, the server may determine whether the user has color vision deficiency, without performing a separate process for determining color vision deficiency. Here, the CAPCHA information may be information for determining whether a macro is being used in an account creation or login process.

For example, among color vision tests, a pseudoisochromatic plate test may be employed for the displayed information used in the CAPCHA information for determining color vision deficiency. Pseudoisochromatic plates are testing plates in which dots of the same color forming a number or shape are arranged together with dots of similar colors that are easy for confusion. People with normal vision may easily identify the number or shape, but people with color vision deficiency may not discriminate the color representing the number or shape from the background colors. However, the pseudoisochromatic plate test is only an example, and a color arrangement test, chromatoscopy, or a lantern test may also be employed.

As shown in the example of FIG. 5, the server may provide a user terminal with a joining form 510 for enrolling information of the user. The user terminal may display the joining form 510 received from the server on a display. The joining form 510 may include an ID field 515, a password field 520, a visual authentication code 525, a visual authentication code field 530, and a create button 535.

The visual authentication code 525 included in the joining form 510 may be provided in a form that may be read differently according to the color vision of the user, and may be provided in the form of an image based on a color vision test. The user may enter a number, a character, or a combination thereof that is read from the visual authentication code 525 as an input value, in the visual authentication code field 530.

A user authentication apparatus may determine whether the user has color vision deficiency based on the input value entered by the user and the visual authentication code 525, and enroll information related to a determination result. The user authentication apparatus may implicitly determine whether the user has color vision deficiency based on the input value entered by the user and the visual authentication code 525.

For example, if the input value entered by the user is “713169” and “713169” is the number that may be read by a user with normal vision from the visual authentication code 525, the user authentication apparatus may enroll color vision information of the user as normal vision. If the input value entered by the user is “718169” and “718169” is the number that may be read by a user with protanopia from the visual authentication code 525, the user authentication apparatus may enroll color vision information of the user as protanopia.

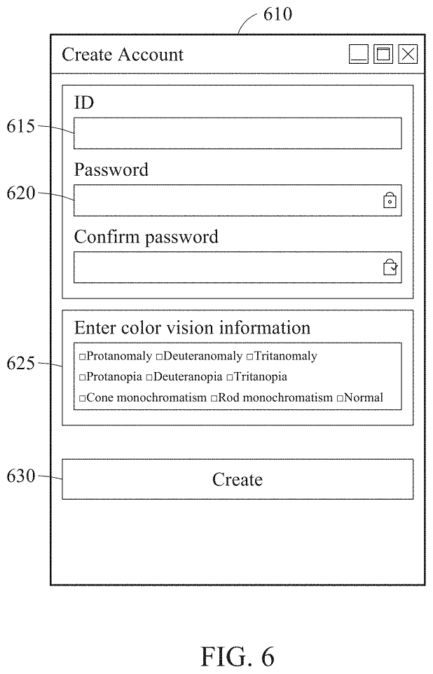

FIG. 6 illustrates an example of a user interface for explicitly collecting color vision information of a user according to an example embodiment.

Referring to FIG. 6, a server may provide a user terminal with a joining form 610 for enrolling information of a user. The user terminal may display the joining form 610 received from the server on a display. The joining form 610 may include an ID field 615, a password field 620, a color vision information field 625, and a create button 630.

The user may enter color vision information of the user in the color vision information field 625 by selecting one of protanomaly, deuteranomaly, tritanomaly, protanopia, deuteranopia, tritanopia, cone monochromatism, rod monochromatism, and normal vision. A user authentication apparatus may enroll information regarding whether the user has color vision deficiency based on the user input.

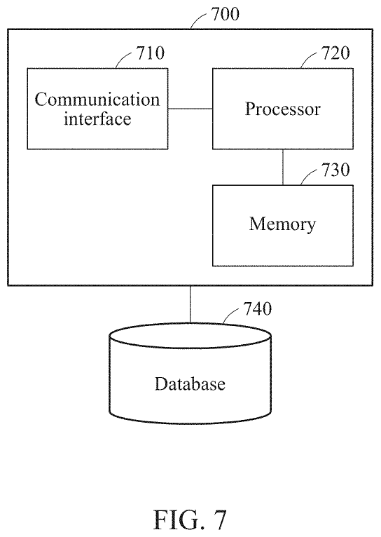

FIG. 7 is a diagram illustrating a configuration of a user authentication apparatus according to an example embodiment.

Referring to FIG. 7, a user authentication apparatus 700 may include a communication interface 710, a processor 720, and a memory 730. The user authentication apparatus 700 may further include a database 740. The user authentication apparatus 700 may correspond to the user authentication apparatus described above.

The memory 730 may be connected to the processor 720, and store instructions executable by the processor 720, data to be computed by the processor 720, or data processed by the processor 720. The memory 730 may include a non-transitory computer-readable medium (for example, a high-speed random access memory) and/or a non-volatile computer-readable medium (for example, at least one disk storage device, flash memory device, or another non-volatile solid-state memory device).

The communication interface 710 may provide an interface to communicate with an external device (for example, a user terminal). The communication interface 710 may communicate with the external device through a wired or wireless network.

The database 740 may store data necessary for the user authentication apparatus 700 to perform user authentication for the user. For example, the database 740 may store color vision information of users. Further, the database 740 may store visual authentication codes, and reference values with respect to the visual authentication codes that may be read differently according to color vision deficiency.

The processor 720 may execute instructions and a function to be executed in the user authentication apparatus 700 and control the overall operation of the user authentication apparatus 700. The processor 720 may be implemented by using a hardware/software combination such as a processor to execute software, hardware including logic circuits, or a processing circuitry such as a combination thereof. For example, the processing circuitry may include a central processing unit (CPU), an arithmetic logic unit (ALU), a digital signal processor, a microcomputer, a field-programmable gate array (FPGA), a system-on-chip (SoC), a programmable logic unit, a microprocessor, or an application-specific integrated circuit (ASIC). However, the range of the examples is not limited thereto.

The processor 720 may perform one or more operations related to the operation of the user authentication apparatus described with reference to FIGS. 1 to 6.

For example, the processor 720 may transmit a visual authentication code that is recognized differently according to color vision deficiency to a user terminal, receive a user input corresponding to the visual authentication code from the user terminal, and determine a user authentication result of a user based on a comparison result obtained by comparing the user input to a reference value determined based on pre-enrolled color vision information of the user. Here, if an input value with respect to the visual authentication code, included in the user input, is the same as the reference value, the processor 720 may determine that a user authentication of the user is successful. If the input value with respect to the visual authentication code, included in the user input, is different from the reference value, the processor 720 may determine that the user authentication of the user is failed.

The units described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter. The above-described devices may be configured to act as one or more software modules in order to perform the operations of the above-described examples, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. A user authentication method based on color vision information, performed by a user authentication apparatus, the user authentication method comprising:
transmitting, to a user terminal, a visual authentication code that is recognized differently according to color vision deficiency;
receiving, from the user terminal, a user input corresponding to the visual authentication code; and
determining a user authentication result of a user based on a comparison result obtained by comparing the user input to a reference value determined based on pre-enrolled color vision information of the user.

2. The user authentication method of claim 1, wherein the determining comprises determining that a user authentication of the user is successful, if an input value with respect to the visual authentication code included in the user input is the same as the reference value.

3. The user authentication method of claim 1, wherein the determining comprises determining that a user authentication of the user is failed, if an input value with respect to the visual authentication code included in the user input is different from the reference value.

4. The user authentication method of claim 1, wherein the pre-enrolled color vision information is determined in a user enrollment procedure based on a user input with respect to color vision information of the user, and includes information regarding whether the user has color vision deficiency.

5. The user authentication method of claim 4, wherein the pre-enrolled color vision information is enrolled information regarding whether the user has color vision deficiency, determined based on an input value with respect to a visual code that is read differently according to color vision deficiency input in the user enrollment procedure.

6. The user authentication method of claim 4, wherein the pre-enrolled color vision information is enrolled information regarding whether the user has color vision deficiency, determined based on a selected value with respect to color vision deficiency input in the user enrollment procedure.

7. The user authentication method of claim 1, wherein the visual authentication code is provided in the form of an image based on a color vision test, and is a number, a character, or a combination thereof that is read differently according to normal vision and color vision deficiency.

8. The user authentication method of claim 7, wherein the visual authentication code is a number, a character, or a combination thereof that is read differently according to at least one of protanomaly, deuteranomaly, tritanomaly, protanopia, deuteranopia, tritanopia, cone monochromatism, and rod monochromatism.

9. A non-transitory computer-readable storage medium storing instructions that, when executed by a processor, cause the processor to perform the user authentication method of claim 1.

10. A user authentication apparatus for performing a user authentication method, the user authentication apparatus comprising:
a memory and a processor,
wherein the memory is configured to store instructions executable by the processor, and
when the instructions are executed by the processor, the processor is configured to:
transmit, to a user terminal, a visual authentication code that is recognized differently according to color vision deficiency,
receive, from the user terminal, a user input corresponding to the visual authentication code, and
determine a user authentication result of a user based on a comparison result obtained by comparing the user input to a reference value determined based on pre-enrolled color vision information of the user.

11. The user authentication apparatus of claim 10, wherein the processor is configured to determine that a user authentication of the user is successful, if an input value with respect to the visual authentication code included in the user input is the same as the reference value.

12. The user authentication apparatus of claim 10, wherein the processor is configured to determine that a user authentication of the user is failed, if an input value with respect to the visual authentication code included in the user input is different from the reference value.

13. The user authentication apparatus of claim 10, wherein the pre-enrolled color vision information is determined in a user enrollment procedure based on a user input with respect to color vision information of the user, and includes information regarding whether the user has color vision deficiency.

14. The user authentication apparatus of claim 13, wherein the pre-enrolled color vision information is enrolled information regarding whether the user has color vision deficiency, determined based on an input value with respect to a visual code that is read differently according to color vision deficiency input in the user enrollment procedure.

15. The user authentication apparatus of claim 13, wherein the pre-enrolled color vision information is enrolled information regarding whether the user has color vision deficiency, determined based on a selected value with respect to color vision deficiency input in the user enrollment procedure.

16. The user authentication apparatus of claim 10, wherein the visual authentication code is provided in the form of an image based on a color vision test, and is a number, a character, or a combination thereof that is read differently according to normal vision and color vision deficiency.

17. The user authentication apparatus of claim 16, wherein the visual authentication code is a number, a character, or a combination thereof that is read differently according to at least one of protanomaly, deuteranomaly, tritanomaly, protanopia, deuteranopia, tritanopia, cone monochromatism, and rod monochromatism.

18. A user authentication method performed by a user terminal, the user authentication method comprising:
receiving, from a user authentication apparatus, a visual authentication code that is recognized differently according to color vision deficiency;
receiving a user input corresponding to the visual authentication code; and
transmitting the received user input to the user authentication apparatus,
wherein the user authentication apparatus is configured to determine a user authentication result of a user based on a comparison result obtained by comparing the user input to a reference value determined based on pre-enrolled color vision information of the user.

19. The user authentication method of claim 18, wherein the user authentication apparatus is configured to:
determine that a user authentication of the user is successful, if an input value with respect to the visual authentication code included in the user input is the same as the reference value, and
determine that a user authentication of the user is failed, if the input value with respect to the visual authentication code included in the user input is different from the reference value.

20. The user authentication method of claim 18, wherein the pre-enrolled color vision information is determined in a user enrollment procedure based on a user input with respect to color vision information of the user, and includes information regarding whether the user has color vision deficiency, and
the visual authentication code is provided in the form of an image based on a color vision test, and is a number, a character, or a combination thereof that is read differently according to normal vision and color vision deficiency.
